(19) United States
(12) Patent Application Publication
(10) Pub. No.: US 2026/0087796 A1
(43) Pub. Date: Mar. 26, 2026

(54) METHOD AND DEVICE FOR PROCESSING A DIGITAL IMAGE FOR ANOMALY OR NORMALITY DETECTION

(71) Applicant: Robert Bosch GmbH, Stuttgart (DE)

(72) Inventors: Daria Stepanova, Leonberg (DE); Kilian Rambach, Stuttgart (DE); Nian Hua, Magstadt (DE); Nicole Ying Finnie, Renningen (DE); Youmna Salah Mahmoud Ismaeil, Stuttgart (DE)

(21) Appl. No.: 19/112,682

(22) PCT Filed: Jan. 11, 2024
(86) PCT No.: PCT/EP2024/050534

§ 371 Date: Mar. 18, 2025

(30) Foreign Application Priority Data
Jan. 18, 2023 (DE) 10 2023 200 345.7

(51) Int. Cl. G06V 10/98; G06T 7/00; G06V 10/74; G06V 10/764

(52) U.S. Cl. CPC G06V 10/993; G06T 7/0002; G06V 10/761; G06V 10/764; G06T 2207/20076; G06T 2207/20081; G06T 2207/20084; G06T 2207/30168

(57) ABSTRACT

A device and a computer implemented method for processing a digital image for anomaly or normality detection. The method includes providing the digital image, determining, depending on the digital image, a first class for a first object and a second class for a second object depicted in the digital image, determining a score depending on semantic similarity between the first class and the second class, and detecting an anomaly or a normality depending on the score.

### FIELD

The present invention relates to a method and a device for processing a digital image for anomaly or normality detection.

### BACKGROUND INFORMATION

Biase, G. D., Blum, H., Siegwart, R., Cadena, C.: “Pixel-wise anomaly detection in complex driving scenes,” in: IEEE Conference on Computer Vision and Pattern Recognition, CVPR 2021, virtual, Jun. 19-25, 2021, pp. 16918-16927, Computer Vision Foundation/IEEE (2021) describes deciding whether a given image is an anomaly on a pixel level.

Eiter, T., Kaminski, T.: “Exploiting contextual knowledge for hybrid classification of visual objects,” in: JELIA. Lecture Notes in Computer Science, vol. 10021, pp. 223-239 (2016) describes classifying images based on manually specified constraints such that none of the constraints is violated.

### SUMMARY

The present invention provides a computer implemented method for processing a digital image. According to an example embodiment of the present invention, the method comprises providing the digital image, determining, depending on the digital image, a first class for a first object and a second class for a second object depicted in the digital image, determining a score depending on semantic similarity between the first class and the second class, and detecting an anomaly or a normality depending on the score. The score represents a pairwise semantic similarity of the classes. The anomaly or normality detection is enhanced by information about the semantic similarity that influences the scores. This improves the result of the detection.

According to an example embodiment of the present invention, the method may comprise determining the score for a plurality of pairs of classes of objects depicted in the digital image, determining a metric depending on the scores determined for the plurality of pairs of classes, and detecting the anomaly or normality depending on the metric.

The metric may comprise a mean of a first score of the scores and a second score or the scores. Basing the detection on this mean of the scores improves the result of the detection further.

The metric may comprise a mean of weighted scores. Basing the detection on this mean of the scores improves the result of the detection further.

The method may comprise determining a probability that the digital image comprises an object of the first class, determining a weight depending on the probability that the digital image comprises the object of the first class and weighting the score for a pair comprising the first class with the first weight. This improves the result of the detection further.

The metric may comprise an extremal score, in particular a minimal score or a maximal score within the scores. This metric is based on the extremal score of the pairs of classes that are considered in the detection. This improves the detection further. By way of definition of the calculation of the scores, the extremal score may represent the most or the least related pair of classes. Depending on the definition, this either improves the detection of the normality or anomaly.

Determining the metric may comprise determining that the first score is smaller than the second score, and determining the metric depending on the first score. By way of definition, the higher score may represent a more or a less related pair of classes. Depending on this definition, considering the smaller score improves either the detection of the normality or the anomaly.

Detecting the anomaly or the normality may comprise comparing the metric to a threshold, and detecting the anomaly or the normality depending on a result of comparing the metric to the threshold.

The method may comprise determining a parameter for indicating a confidence depending on a difference between the metric and the threshold. This provides additional information for explaining the detection.

Determining the metric may comprise determining a list comprising a plurality of scores in particular ordered in the list in an ascending or descending order. This facilitates computations.

Detecting the anomaly or the normality may comprise classifying the list, in particular with a classifier, which has an output for indicating anomaly and/or an output for indicating normality. This improves the performance of the detection further.

The method may comprise determining an action or an output of a device depending on a detection of normality or anomaly.

The present invention provides a device for processing a digital image for anomaly or normality detection. According to an example embodiment of the present invention, the device comprises at least one processor and at least one memory, wherein the at least one processor is configured to execute instructions that, when executed by the at least one processor cause the device to execute the method of the present invention and wherein the at least one memory is configured to store the instructions. This device has advantages as described for the method.

The present invention further provides a computer program that comprises instructions that, when executed by a computer, cause the computer to execute the method of the present invention, and has advantages as described for the method of the present invention.

Further advantageous embodiments of the present invention are derived from the following description and the figures.

### BRIEF DESCRIPTION OF THE DRAWINGS

FIG. 1 schematically depicts a device for processing digital images, according to an example embodiment of the present invention.

FIG. 2 schematically depicts a first digital image, according to an example embodiment of the present invention.

FIG. 3 schematically depicts a second digital image, according to an example embodiment of the present invention.

FIG. 4 schematically depicts a method for processing digital images, according to an example embodiment of the present invention.

### DETAILED DESCRIPTION OF EXAMPLE EMBODIMENTS

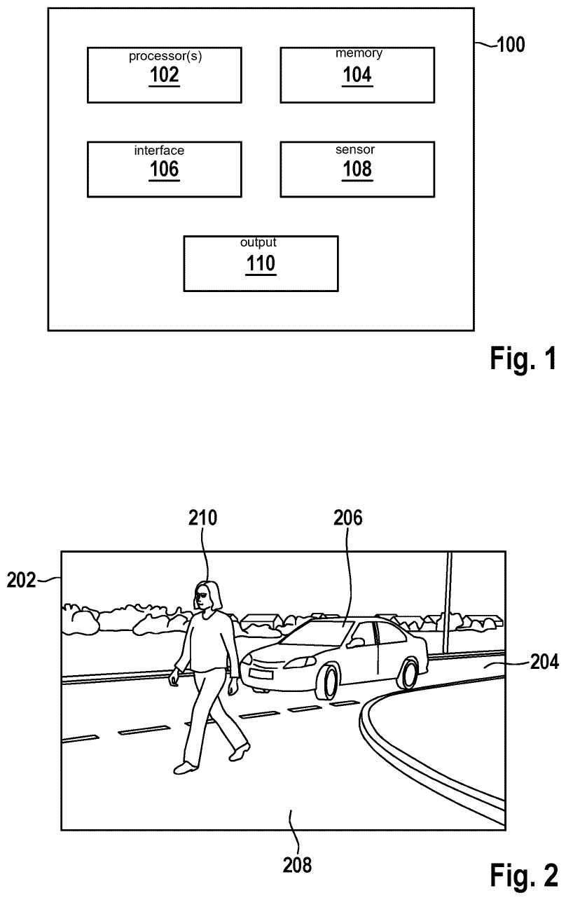

FIG. 1 schematically depicts a device 100 for processing digital images.

The device 100 comprises at least one processor 102 and at least one memory 104.

The device 100 comprises an interface 106 for a sensor 108 and/or the sensor 108. In the example depicted in FIG. 1, the device 100 comprises the sensor 108.

The sensor 108 is for example a camera, a radar sensor, a LiDAR sensor, a motion sensor, an infrared sensor or an ultrasonic sensor.

The sensor 108 is configured to capture a digital image. The sensor 108 is in one example configured to capture sensor data from the sensor 108 or a plurality of sensors 108 for determining the digital image e.g. of an environment of the device 100. The digital image may be determined by the device 100 depending on the sensor data.

The digital image represents visual data, radar data, LiDAR data, ultrasonic data or a combination thereof.

The device 100 may be configured for detecting objects in the digital image. In one example, the device 100 is configured to detect the objects from a set of digital images captured by the sensor 108.

The device 100 may be configured for detecting classes of objects in the digital image. In one example, the device 100 is configured to detect the classes from a set of digital images captured by the sensor 108.

The present invention relates to a problem of semantic anomaly detection, to decide if a certain measured scene or scenario is normal or abnormal: Given some input data, e.g., a set of images, the device 100 is configured to decide whether they depict a realistic, i.e. a normal, combination of objects or a unrealistic, i.e. an abnormal, combination. As an example a combination of objects like a car, a pedestrian, a street corresponds to a normal situation, whereas a combination of a car, a tiger, a street is considered in this disclosure as abnormal situation.

The considered problem is important and relevant in a number of applications, e.g., autonomous driving or visual inspection of products assembled by robots.

For example, in the autonomous driving domain, the device 100 is an autonomous vehicle or a part thereof that is configured to reliably distinguish a normal combination of objects from an abnormal combination of objects. The device 100 is configured to base its decision on the normal combination of objects. The device 100 is in one example configured to detect a scene with an unusual combination of objects as a normal scene. The device 100 is for example configured to detect a scene comprising as objects a ride-on car, a pedestrian, and a street as a normal scene. The device 100 is in one example configured to detect a scene with an unusual combination of objects as an abnormal scene. The device 100 is in one example configured to distinguish whether an unusual combination of objects represents a normal scene or an abnormal scene.

For example, in the manufacturing domain, the device 100 is an assembly or a part thereof that is configured to detect a combination of parts of a product, in particular a product that is automatically manufactured. The device 100 is configured to distinguish whether the detected combination of parts represents a normal combination of the parts or an abnormal combination of parts. The device 100 is for example configured to detect that the product comprises a plastic top and a metal bottom. The device 100 is for example configured to detect that this combinations is abnormal, e.g., for a particular electronic control unit architecture. The device 100 is configured to identify issues with the product in case the abnormal combination is detected.

The device 100 may comprise an output 110. The output 110 is for example configured to output a result of detecting normality or anomaly. The output 110 may be configured to control an operation of the device 100, e.g. an action by the device 100.

FIG. 2 depicts a first digital image 202. The first digital image 202 depicts a part of a road 204 and a vehicle 206. The vehicle 206 moves on the road 204 towards an intersecting road 208. A pedestrian 210 crosses the intersecting road 208 while the vehicle 206 indicates an intention to turn into the intersecting road 208. The first digital image 202 is a normal digital image. Normal digital image refers to a digital image that captures a scene that is likely to happen in a real world scenario.

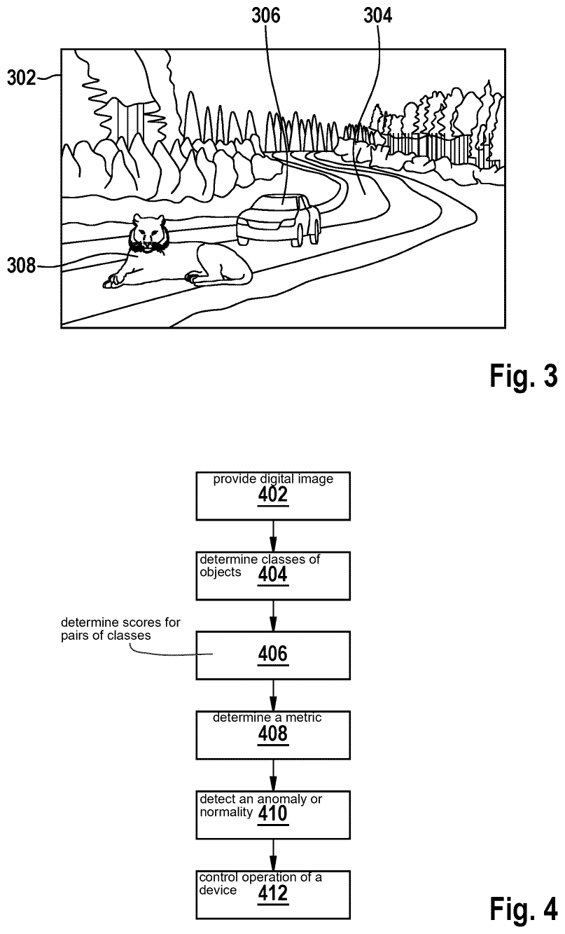

FIG. 3 depicts a second digital image 302. The second digital image 302 depicts a part of a road 304 and a vehicle 306. The vehicle 306 moves on the road 304 towards a tiger 308 that sits on the road 304. The second digital image 302 is an abnormal digital image. Abnormal digital image refers to a digital image that captures a scene that is not likely to happen in a real world scenario.

The at least one memory 104 is configured to store instructions that, when executed by the at least one processor 102, cause the device 100 to execute steps in a method for processing digital images.

The at least one memory 104 is configured to store a knowledge graph. The knowledge graph comprises nodes that represent classes for object that are present in digital images. The knowledge graph comprises edges that connect nodes of the knowledge graph pairwise. The edges represent relations between the nodes and thus between the classes they represent.

The knowledge graph represents an interlinked collection of factual information in particular as a directed graph.

The knowledge graph is for example encoded as a set of (subject; predicate; object) triples. In a triple, its subject corresponds to a node, its object corresponds to a node, and its predicate corresponds to an edge.

FIG. 4 depicts steps of the method.

The method processes a digital image to detect an anomaly or a normality of the digital image. Anomaly refers to an abnormal digital image. Normality refers to a normal digital image.

In a step 402, a digital image is provided.

The digital image is for example captured by the sensor 108.

The digital image comprises objects.

In a step 404, classes of the objects are determined.

A plurality of classes is provided. For at least one class of the plurality of classes a probability is determined that the digital image comprises an object of the class. The probability indicates a likelihood that the digital image comprises an object of the at least one class.

According to one example, the probability for the at least one class is determined depending on the digital image.

According to one example, the objects are detected and a class is determined for at least one of the objects.

According to one example, the probability that the object is of a class of the plurality of classes is determined for the classes of the plurality of classes.

The objects are detected for example with an object detector. The probabilities or the classes are determined for example with a classifier. An already pre-trained existing classifier or object detector may be used.

In one example, for an object, the classifier assigns a plurality of probabilities, wherein a probability of the plurality of probabilities indicates for one of the classes of the plurality of classes the likelihood that the object is of this class.

The method may use object detection or may determine probabilities of classes of objects without object detection.

An example for classifying detected objects with the classifier or object detector is the CLIP model described in Radford, A., Kim, J. W., Hallacy, C., Ramesh, A., Goh, G., Agarwal, S., Sastry, G., Askell, A., Mishkin, P., Clark, J., Krueger, G., Sutskever, I., “Learning transferable visual models from natural language supervision,” in: ICML. Proceedings of Machine Learning Research, vol. 139, pp. 8748-8763. PMLR (2021).

The method is explained further considering a first class, a second class, and a third class of the plurality of classes.

The first class, the second class, and the third class is determined depending on the digital image. A first probability for an object of the first class being depicted in the digital image is determined for the first class. A second probability for an object of the second class being depicted in the digital image is determined for the second class. A third probability for an object of the third class being depicted in the digital image is determined for the third class.

Other probabilities may be determined for other classes.

In a step 406, scores sᵢⱼ are determined for pairs of classes comprising a class i and a class j.

The score sᵢⱼ is determined for a plurality of pairs of classes of objects depicted in the digital image,

The score sᵢⱼ for a pair is determined depending on a semantic similarity between the class i and the class j. The semantic similarity is determined depending on the knowledge graph.

According to an example the higher a score is, the more related are the classes that are used to determine the score. This means, the higher the score for a pair of classes is, the more likely it is, that the combination of the objects of the two classes in the pair represent a normal digital image. This means, the lower the score for a pair of classes is, the more likely it is, that the combination of the objects of the two classes in the pair represent an abnormal digital image.

The definition of the scores may be vice-versa and the determination of the following metric and the detection may be adapted accordingly.

The method may comprise determining the scores for arbitrary pairs of classes of the plurality of classes.

The knowledge graph is e.g. ConceptNet or WebChild to account for the semantic relatedness of objects that can occur in the scene. ConceptNet is described in Speer, R., Chin, J., Havasi, C., “Conceptnet 5.5: An open multilingual graph of general knowledge,” in: AAAI. pp. 4444-4451. AAAI Press (2017).

WebChild is described in Tandon, N., de Melo, G., Suchanek, F. M., Weikum, G., “Webchild: harvesting and organizing commonsense knowledge from the web,” in: WSDM. pp. 523-532. ACM (2014).

The scores may be determined for pairs of classes that are assigned higher probability than other classes. In one example, the scores are determined for k classes that are assigned the top probabilities:

According to an example, classes are selected for determining the scores depending on their probability.

The classes are selected for determining the scores in one example because the probability that is assigned to these classes is higher than the probability that is assigned to other classes.

A score is determined for the two classes. The score is determined depending on a semantic similarity between the classes.

In a step 408, a metric is determined depending on the first score and the second score.

Determining the metric in one example comprises determining a mean of the scores.

In one example, the mean of the first score and the second score is determined.

In one example, the mean of the k scores Sy having the highest probability is determined:

$${m}_{topk} = \frac{1}{k ( k - 1 )} {{\sum }_{i , j = 1 , … , k}}_{i > j} . {s}_{i j}$$

Determining the metric in one example comprises determining a mean of weighted scores.

In one example, the mean of weighted scores is determined with a weight pᵢ for a class i and a weight pⱼ for a class j and with the k scores sᵢⱼ having the highest probability:

$${m}_{weightedk} = \frac{1}{k ( k - 1 )} {{\sum }_{i , j = 1 , … , k}}_{i > j} {p}_{i} , {p}_{j} {s}_{ij}$$

The weights are determined in one example depending on the probabilities that are assigned to the classes for that the score is determined that is weighted by the weight.

In one example, the mean is determined depending on weighted scores.

The weighted first score is for example determined depending on a first weight and the first score. The weighted second score is for example determined depending on a second weight and the second score.

For example, the first weight is determined depending on the probability that the digital image comprises an object of the first class and the probability that the digital image comprises an object of the second class. For example, the second weight is determined depending on the probability that the digital image comprises an object of the first class and the probability that the digital image comprises an object of the third class.

Weighing may be based on human predefined rules, e.g. humans define a pair of classes toddler and car should weigh more than its unweighted original semantic score, because it could be a dangerous/anomaly situation. Weights may be determined by predefined rules or field of applications. In some embodiments, not all anomalies or all scores are equal. The rules may be used to identify pairs of classes as abnormal that, based on their unweighted original semantic score, seem normal.

Determining the metric in one example comprises determining an extremal score. The extremal score may be a minimal score or a maximal score, in a plurality of scores that are determined for the digital image.

For the minimal score, e.g. a minimum of the k scores sᵢⱼ having the highest probability is determined:

$${m}_{mink} = {{min}_{i , j = 1 , … , k}}_{i > j} {s}_{i j}$$

The method is not limited to using the minimal or maximal score. The method may comprise finding a small score that is not necessarily the minimum score. The method may comprise finding a large score that is not necessarily the maximum score. Determining the metric may comprise determining that a first score of the scores is smaller than a second score of the scores, and determining the metric depending on the first score.

Instead of determining a scalar metric as described above, determining the metric may comprise determining a list comprising a plurality of scores in particular ordered in the list in an ascending or descending order.

In a step 410, an anomaly or a normality is detected depending on the metric.

According to an example, detecting the anomaly comprises determining that the metric is smaller than a threshold.

According to an example, detecting the normality comprises determining that the metric is larger than or equal to the threshold.

The threshold may be determined in a training.

For example, the scalar metric is determined for a plurality of digital images that comprises images that are known to show a normal scene and digital images that are known to show an anomaly.

The threshold is selected to a largest possible value such that anomaly is detected correctly for a predetermined amount or percentage of digital images of the plurality of digital images, anomaly is detected falsely for a predetermined amount or percentage of digital images of the plurality of digital images, normality is detected correctly for a predetermined amount or percentage of digital images of the plurality of images and/or normality is detected falsely for a predetermined amount or percentage of digital images of the plurality of images.

Preferably, the threshold is determined from digital images that are known to show a normal scene. The threshold can be tuned based on the experimental scores. If most normal pairs yield >0.2 then 0.2 can be chosen as a threshold. The threshold is selected to a largest possible value such that normality is detected correctly for a predetermined amount or percentage of digital images of the plurality of images or anomaly is detected falsely for a predetermined amount or percentage of digital images of the plurality of digital images. This avoids using digital images comprising an abnormality.

The different lists of classes may be defined as examples of abnormal and normal combinations. The class names are used to compute the scores and the corresponding scalar metric.

A suitable threshold is chosen as described above from the class names instead of digital images. The advantage of this approach is that no input data for the classifier of the digital images is needed.

The method may comprise determining a parameter for indicating a confidence depending on a difference between the metric and the threshold it is compared to.

Detecting the anomaly or the normality may comprise classifying the list, in particular with a classifier, which has an output for indicating anomaly and/or an output for indicating normality. The classifier may be a neural network that is configured to process the list to determine the output.

An example of such neural network comprises two fully connected layers. More complex neural networks are possible. When trained appropriately, the activation function output of the neural network, e.g. softmax, can be used as the confidence score for the detection. Alternatively, the output can be calibrated with uncertainty methods and used as the confidence score of detection.

The result of detecting normality or anomaly may be stored or output. The result may indicate anomaly or normality of the digital image. The result may comprise the confidence as well.

During the training, not all possible classes, which are seen during inference, have to be used. During the training, a suitable threshold or suitable network weights are learned. Through the information in the knowledge graph, new class pairs, which have similar high or low similarity scores, still lead to correct normal or abnormal classification results.

In a step 412, an operation of the device 100, e.g. an output or an action by the device 100, may be controlled depending on the result.

For example, the digital image may be used for determining an action of the device 100 in case the result indicates normality of the digital image.

For example, the digital image may be disregarded for determining an action of the device 100 in case the result indicates anomaly of the digital image.

In the field of autonomous driving, the action may be driving the vehicle.

In the field of manufacturing, the action may be using or sorting out the product.

1-14. (canceled)

15. A computer implemented method for processing a digital image for anomaly or normality detection, the method comprising the following steps:
providing the digital image;
determining, depending on the digital image, a first class for a first object depicted in the digital image and a second class for a second object depicted in the digital image;
determining a score depending on semantic similarity between the first class and the second class; and
detecting the anomaly or the normality depending on the score.

16. The method according to claim 15, further comprising:
determining the score for a plurality of pairs of classes of objects depicted in the digital image;
determining a metric depending on the scores determined for the plurality of pairs of classes; and
detecting the anomaly or normality depending on the metric.

17. The method according to claim 16, wherein the metric includes a mean of the scores.

18. The method according to claim 17, wherein the metric includes a mean of weighted scores.

19. The method according to claim 18, further comprising:
determining a probability that the digital image includes an object of the first class;
determining a first weight depending on the probability that the digital image includes the object of the first class; and
weighting the score for a pair including the first class with the first weight.

20. The method according to claim 16, wherein the metric includes an extremal score, the extremal score being a minimal score or a maximal score within the scores.

21. The method according to claim 16, wherein the determining of the metric includes determining that a first score of the scores is smaller than a second score or the scores, and determining the metric depending on the first score.

22. The method according to claim 16, wherein the detecting of the anomaly or the normality includes comparing the metric to a threshold and detecting the anomaly or the normality depending on a result of comparing the metric to the threshold.

23. The method according to claim 22, further comprising:
determining a parameter for indicating a confidence depending on a difference between the metric and the threshold.

24. The method according to claim 16, wherein the determining of the metric includes determining a list including the scores ordered in the list in an ascending or descending order.

25. The method according to claim 24, wherein the detecting of the anomaly or the normality includes classifying the list with a classifier, which has an output for indicating anomaly and/or an output for indicating normality.

26. The method according to claim 15, further comprising:
determining an action or an output of a device depending on a detection of the normality or the anomaly.

27. A device for processing a digital image for anomaly or normality detection, the device comprising:
at least one processor; and
at least one memory;
wherein the at least one processor is configured to execute instructions that, when executed by the at least one processor cause the device to execute a method for processing a digital image for anomaly or normality detection, the method including the following steps:
providing the digital image,
determining, depending on the digital image, a first class for a first object depicted in the digital image and a second class for a second object depicted in the digital image,
determining a score depending on semantic similarity between the first class and the second class, and
detecting the anomaly or the normality depending on the score.

28. A non-transitory computer-readable medium on which is stored a computer program including instructions for processing a digital image for anomaly or normality detection, the instructions, when executed by at least one processor, causing the at least one processor to perform the following steps:
providing the digital image;
determining, depending on the digital image, a first class for a first object depicted in the digital image and a second class for a second object depicted in the digital image;
determining a score depending on semantic similarity between the first class and the second class; and
detecting the anomaly or the normality depending on the score.
